(19) United States
(12) Patent Application Publication
(10) Pub. No.: US 2003/0133383 A1
(43) Pub. Date: Jul. 17, 2003

(54) Information sorage medium,information recording apparatus, and information playback apparatus

(76) Inventors: Kazuo Watabe, Yokohama-shi (JP); Shintaro Takehara, Yokohama-shi (JP); Akihito Ogawa, Yokohama-shi (JP); Kazuto Kuroda, Kawasaki-shi (JP); Hideo Ando, Hino-shi (JP); You Yoshioka, Yokohama-shi (JP)

Correspondence Address: PILLSBURY WINTHROP, LLP, P.O. BOX 10500, MCLEAN, VA, 22102, US

(21) Appl. No.: 10/329,983

(22) Filed: Dec. 27, 2002

(30) Foreign Application Priority Data
Dec. 28, 2001 (JP) 2001-401682

(51) Int. Cl. G11B 7/00

(52) U.S. Cl. 369/53.35; 369/275.4

(57) ABSTRACT

An information storage medium which stores data with an error correction code includes wobble grooves, whose wobble period is modulated in correspondence with address information, in which a length smaller than the maximum error-correctable data length of the data with the error correction code, which is stored along the wobble grooves, is defined as a basic unit, and the address information in the basic unit is reflected in the modulation of the wobble period of the wobble grooves.

### CROSS-REFERENCE TO RELATED APPLICATIONS

This application is based upon and claims the benefit of priority from the prior Japanese Patent Application No. 2001-401682, filed Dec. 28, 2001, the entire contents of which are incorporated herein by reference.

### BACKGROUND OF THE INVENTION

1. Field of the Invention

The present invention relates to an information storage medium having grooves concentrically or spirally formed. The present invention also relates to an information recording apparatus for recording information on the information storage medium having grooves concentrically or spirally formed. The present invention also relates to an information playback apparatus for playing back information from the information storage medium having grooves concentrically or spirally formed.

2. Description of the Related Art

Research and development of large-capacity information storage media such as optical disks are recently advancing. In a CD-R capable of recording information or a CD-RW capable of rewriting information, recording tracks radially wobble. Pieces of address information on the disk are reflected (recorded) in the wobbles. These pieces of address information are recorded by frequency-modulating address data and wobbling tracks in accordance with the modulated carrier signal.

Jpn. Pat. Appln. KOKAI Publication No. 2001-118255 discloses a technique for recording address information on a disk surface as a change in phase of wobbles. Pieces of recording information, i.e., user information to be played back are laid out at a predetermined layout period. The recording information contains a sync signal for synchronization in recording or playing back the information. When the recording information is recorded on tracks, the interval of a change in phase of the wobbles on the tracks is N times (N is a positive integer) of the layout period of sync signals. In addition, one piece of address information is indicated by the track length of user information corresponding to 16 sectors.

In the above-described prior art, however, the recording density of address information is low regardless of whether the wobble modulation scheme is frequency modulation or phase modulation. For this reason, a large track length is required to record one address. For example, an area corresponding to 16 sectors is necessary for one address, as described above. In other words, tracks corresponding to 16 sectors must be played back to define one address. A tracking error that may occur during a write is detected from a wobble signal obtained by playing back tracks corresponding to 16 sectors. For this reason, an erase error due to the tracking error in the write mode ranges over 16 sectors at maximum. The erase error over 16 sectors means that all data in an error correction code block is destroyed. Data restoration is impossible as a matter of course.

### BRIEF SUMMARY OF THE INVENTION

It is an object of the present invention to provide an information storage medium in which pieces of address information are reflected in tracks at a high density.

An information storage medium of the present invention has the following arrangement.

An information storage medium of the present invention is an information storage medium which stores data with an error correction code, comprising wobble grooves whose wobble period is modulated in correspondence with address information, wherein a length smaller than the maximum error-correctable data length of the data with the error correction code, which is stored along the wobble grooves, is defined as a basic unit, and the address information in the basic unit is reflected in modulation of the wobble period of the wobble grooves.

Additional objects and advantages of the invention will be set forth in the description which follows, and in part will be obvious from the description, or may be learned by practice of the present invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the present invention and, together with the general description given above and the detailed description of the preferred embodiments given below, serve to explain the principles of the present invention.

FIG. 1 is a view showing the structure of an information storage medium of the present invention;

FIG. 2 is a view showing the layout of address data corresponding to user data which forms one segment by two sectors;

FIG. 3 is a view showing the internal layouts of the user data and address data which form one segment by two sectors;

FIG. 4 is a view showing the data structure of one ECC block;

FIG. 5 is a graph showing a multi-frequency for track modulation;

FIG. 6 is a view showing the layout of address data corresponding to user data which form one segment by four sectors;

FIG. 7 is a view showing the internal layouts of the user data and address data which form one segment by four sectors; and

FIG. 8 is a block diagram showing the schematic arrangement of an information recording/playback apparatus according to an embodiment of the present invention.

### DETAILED DESCRIPTION OF THE INVENTION

The gist of the present invention will be described first.

An information storage medium according to an embodiment of the present invention has wobble grooves whose wobble period is modulated by MFSK (Multi-Frequency Shift Keying) corresponding to playback control information. The playback control information contains address data that indicates the location of information that is being played back on the disk. The pieces of address information are reflected in the modulated wobble period of the wobble grooves using, as a basic unit, a length smaller than the maximum error-correctable data length of data with error correction codes, which are stored along the wobble grooves.

When the multi-frequency is used, the pieces of playback control information can be reflected in the wobble grooves at a high density. That is, playback control information can be reflected in a short wobble groove. As a result, address information can be defined by playing back information in a length smaller than the maximum error-correctable data length. Hence, even when a tracking error takes place during a write, and existing data is erroneously erased, the size of the erroneously erased data can be suppressed to a size restorable by the error correction code. That is, the problem of erase error can actually be solved.

An embodiment of the present invention will be described below with reference to the several views of the accompanying drawing.

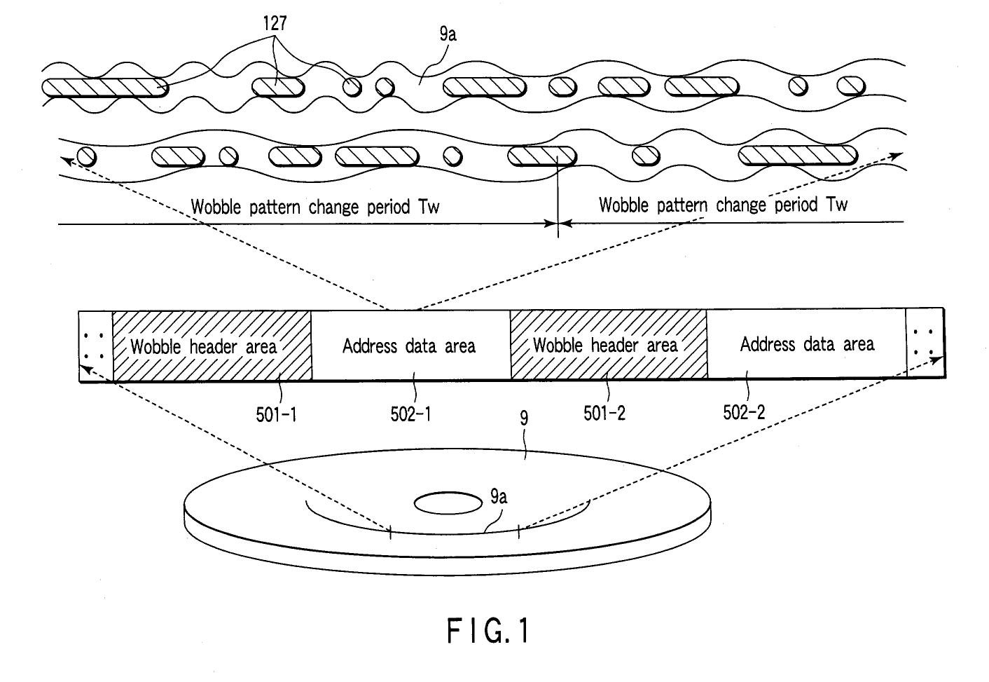

FIG. 1 is a view showing the structure of an information storage medium 9 according to an embodiment of the present invention.

Grooves 9a are concentrically or spirally formed on the information storage medium 9. A recessed portion of the groove 9a is called a land, and a projecting portion is called a groove. One round along the groove 9a is called a track. As shown in FIG. 1, user data is recorded along the tracks. The information is played back by irradiating the information storage medium 9 with a laser beam and reading a change in reflected light intensity depending on recording marks 127 on the tracks.

The grooves 9a on the information storage medium 9 radially wobble. In the present invention, the wobble period changes to record address data representing the location of information that is being played back on the disk, and the like. Hence, user data and address data are recorded while physically overlapping. The data is simultaneously played back by an information playback apparatus (to be described later).

The structure of address data is shown in the middle of FIG. 1. The address data is formed from a wobble header area 501 and address data area 502.

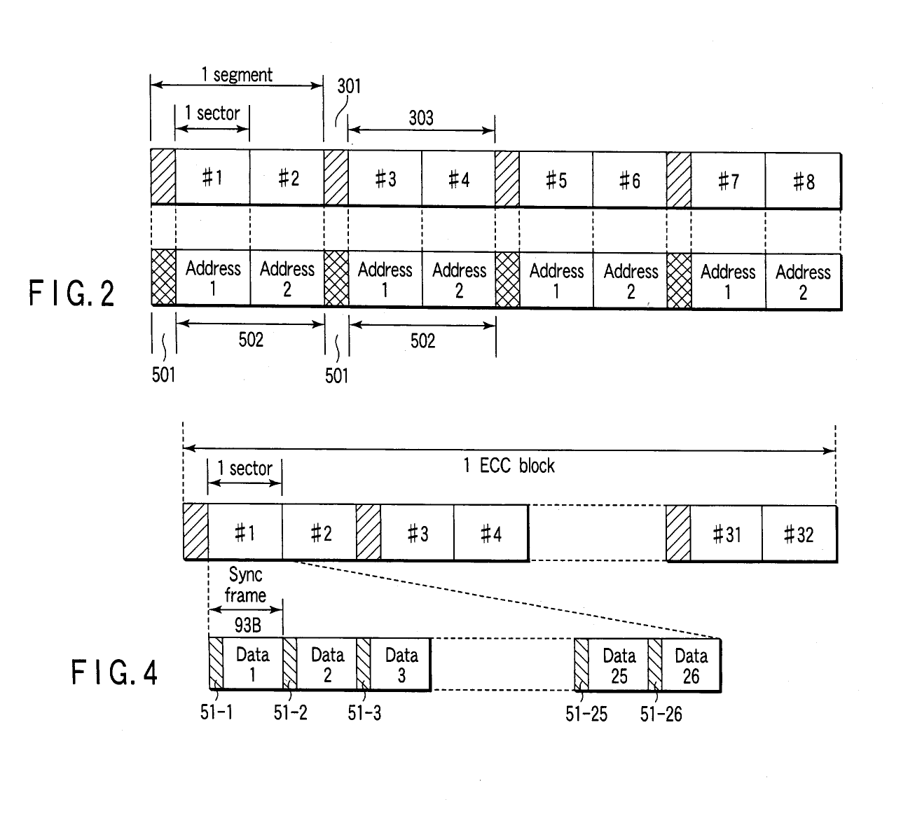

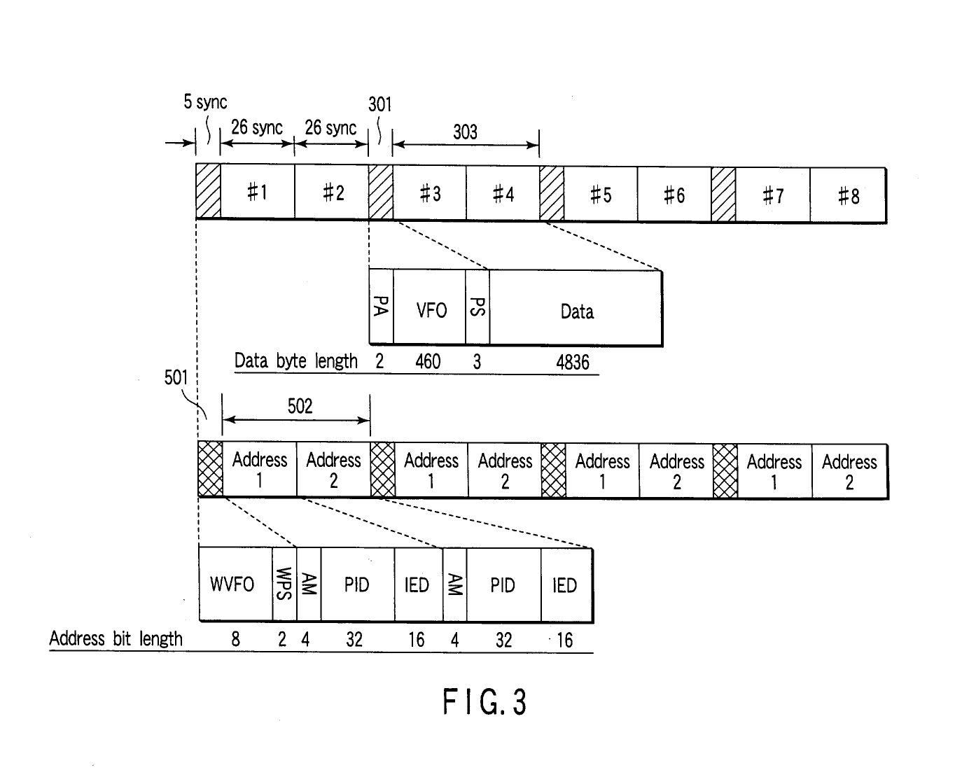

The first embodiment of the present invention will be described below with reference to FIGS. 2 and 3.

FIG. 2 is a view showing the layout of user data and address data. The layout of user data is shown on the upper side of FIG. 2. The layout of address data is shown on the lower side of FIG. 2. User data is recorded using a set of two sectors each serving as a unit. This set is called a segment. One segment is formed from an intermediate area 301 and user data recording area 303.

On the other hand, for address data, an address is given to one segment. The wobble header area 501 and address data area 502 are recorded in each segment, as described above. Two addresses (address 1 and address 2) with identical contents are written in the address data area 502 to ensure the reliability for playback. One of the two addresses has the same length as that of one sector of user data. Two addresses need not always be written. Only one address may suffice if the reliability for playback can be ensured.

FIG. 3 shows the internal layouts of user data and address data. The intermediate area 301 of user data is divided into a VFO (Variable Frequency Oscillator) field, PS (Pre-Sync) field, and PA (Postamble) field. The user data recording area 303 is formed from a data field where user data corresponding to two sectors is recorded. The VFO field gives synchronization to the variable frequency oscillator of the phase-locked loop of the read channel bits of user data. The PS field gives byte synchronization for the following data field. The PA field contains data which completes the last byte of the preceding data field on the basis of the modulation scheme. The PS field and PA field are arranged before and after the data field, respectively, as is apparent from their roles. Hence, no PA field is present in the intermediate area at the start of user data.

On the other hand, the wobble header area 501 of address data contains a WVFO (Wobble VFO) field and WPS (Wobble PS) field. Each of two addresses in the address data area 502 is formed from an AM (Address Mark) field, PID (Physical ID) field, and IED (ID Error Detection code) field. The WVFO field gives synchronization to the variable frequency oscillator of the phase-locked loop of the read channel bits of address data. The WPS field indicates the end position of the wobble header area 501 and also indicates that the address data area 502 immediately follows. The AM field gives byte synchronization for the next PID field. Data such as the reserved area, PID number, sector type, layer number, and segment number are stored in the PID field. The IED (ID Error Detection code) field is used to detect an error generated in the data in the PID field.

The length of each item of data will be described next. As shown in FIG. 4, the large unit of user data is an ECC block, i.e., a unit of error correction. One ECC block is formed from, e.g., 32 sectors. When one segment has two sectors, one ECC block has 16 segments. Each sector of the ECC block is divided into a plurality of frames. A sync code 51 for data synchronization is added to the start of each frame. The unit given to this sync code is called a sync frame. One sector is formed from, e.g., 26 sync frames. One sync frame has a length of, e.g., 93 bytes.

The length of each field in FIG. 3 will be described next. The intermediate area 301 has a length corresponding to, e.g., five sync frames. Since one sync frame has a length of 93 bytes, as described above, the VFO field and PS and PA fields have a total length of 465 bytes. More specifically, the VFO field has a length of 460 bytes, the PS field has a length of three bytes, and the PA field has a length of two bytes. The user data recording area 303 has a length of 52 sync frames corresponding to user data of two sectors. This length corresponds to 4,836 bytes.

As shown in FIG. 3, the intermediate area 301 of user data and the wobble header area 501 of user data, or the user data recording area 303 and address data area 502 are in a one-to-one correspondence. The data item corresponding to each other are physically recorded at almost the same position on the tracks. As described above, each of two address data item has a length corresponding to one sector, i.e., 26 sync frames. The wobble header area 501 has a length corresponding to, e.g., five sync frames, i.e., 465 bytes.

As described above, address data is arranged for each segment. Even when a tracking error occurs during a write of user data, and data is erroneously written on existing user data, the erase error is limited to one segment at maximum. When an error length correctable by ECC ranges over two or more sectors, the data can be restored because the erase error due to the tracking error during the write is limited to two or fewer sectors. One segment has a length corresponding to two sectors here. However, the segment length can be changed depending on the error length correctable by ECC. For example, if the error length correctable by ECC ranges over 1.5 sectors, one segment must be set within the 1.5 sectors. Conversely, if the error length correctable by ECC ranges over 3.5 sectors, the segment length may be three sectors. In this embodiment, one ECC block is formed from 32 sectors. At this time, the correctable error length ranges over two or more sectors, and address data is added for every two sectors. Hence, an erase error due to a tracking error during a user data write is limited to two or fewer sectors, i.e., theoretically correctable range.

Details of address data will be described next.

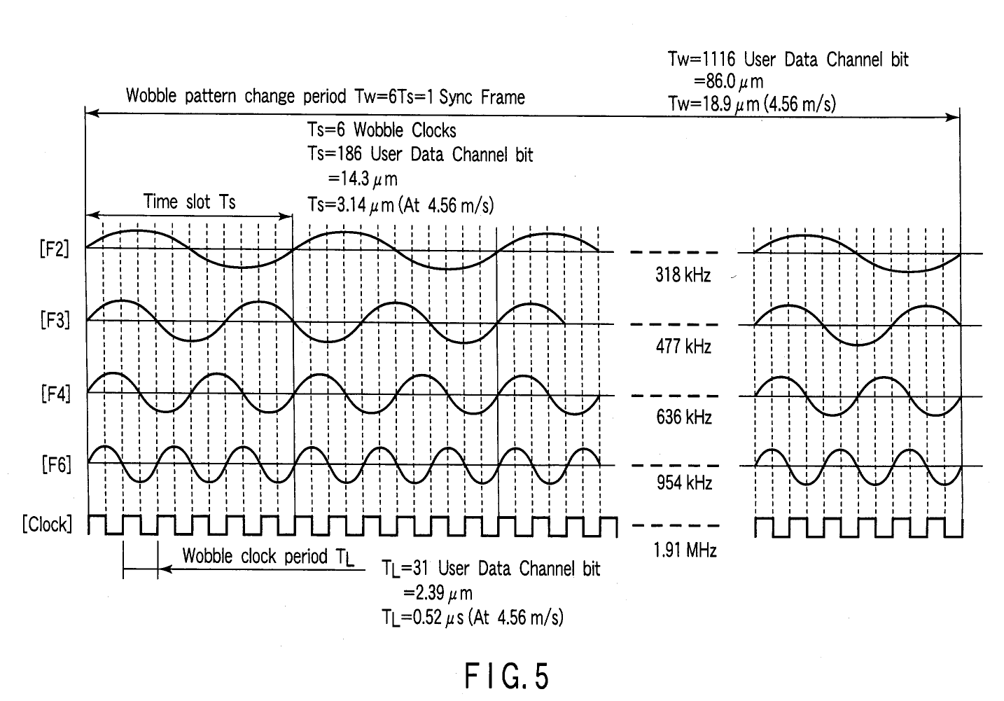

As shown in FIG. 3, the wobble header area 501 has a length of five sync frames, and 10-bit data is recorded by address bits recorded as wobbles. Eight bits of this data are assigned to the WVFO field, and two bits are assigned to the WPS field. Each of the two address data items written in the address data area 502 has a length of 26 sync frames, so 52-bit data are recorded by address bits. Of the 52 bits, four bits are assigned to the AM field, 32 bits are assigned to the PID field, and 16 bits are assigned to the IED field. As described above, in the wobble header area 501, 10 address bits are recorded in five sync frames. In the address data area 502, 52 address bits are recorded in 26 sync frames. Hence, two bits are recorded in one sync frame by wobbles. In this embodiment, hence, MFSK (Multi-frequency Shift Keying) capable of recording 2-bit information by one symbol is used. FIG. 5 shows the pattern of a wobble address modulation signal in this embodiment. A wobble signal records address data of one symbol by one sync frame. One symbol is recorded by four sine waves having different frequencies as shown in FIG. 5. More specifically, the 4-frequency modulation scheme in which data of four states=two bits are recorded by one symbol is employed. Hence, 52-bit data can be recorded by 26 symbols=26 sync frames. The four different frequencies are selected such that, for example, one sync frame contains waveforms of six cycles, nine cycles, 12 cycles, or 18 cycles.

When one sync frame has a length of 93 bytes, and the conversion ratio of user data to channel bit data, which is determined by the modulation scheme, is 2:3, one sync frame has a length of 1,116 channel bits (c.b.). In this case, the lengths of the wobbles of the respective frequency signals shown in FIG. 5 are 186 c.b., 124 c.b., 93 c.b., and 62 c.b., respectively. When the channel bit length is 0.077 μm, and the playback linear speed is 4.56 m/s, the frequencies of the respective signals are 318 kHz(F2), 477 kHz(F3), 636 kHz(F4), and 954 kHz(F6), respectively. When one cycle of the signal F2 with the lowest frequency is one time slot interval Ts, Ts is 3.14 μs, and its length on the disk is 14.3 μm. When one symbol is assigned to each time slot Ts, the recording efficiency is highest. However, this poses the following problems (1) to (3).

(1) If even a small physical defect is present in a wobble pattern, a detection error or data shift readily occurs.

(2) Delimiters of symbols are difficult to detect.

(3) The reliability of data detection for each symbol is low.

To solve these problems, a plurality of time slots are assigned to each symbol such that Tw=LTs (L is an integer). A predetermined frequency is set throughout one symbol.

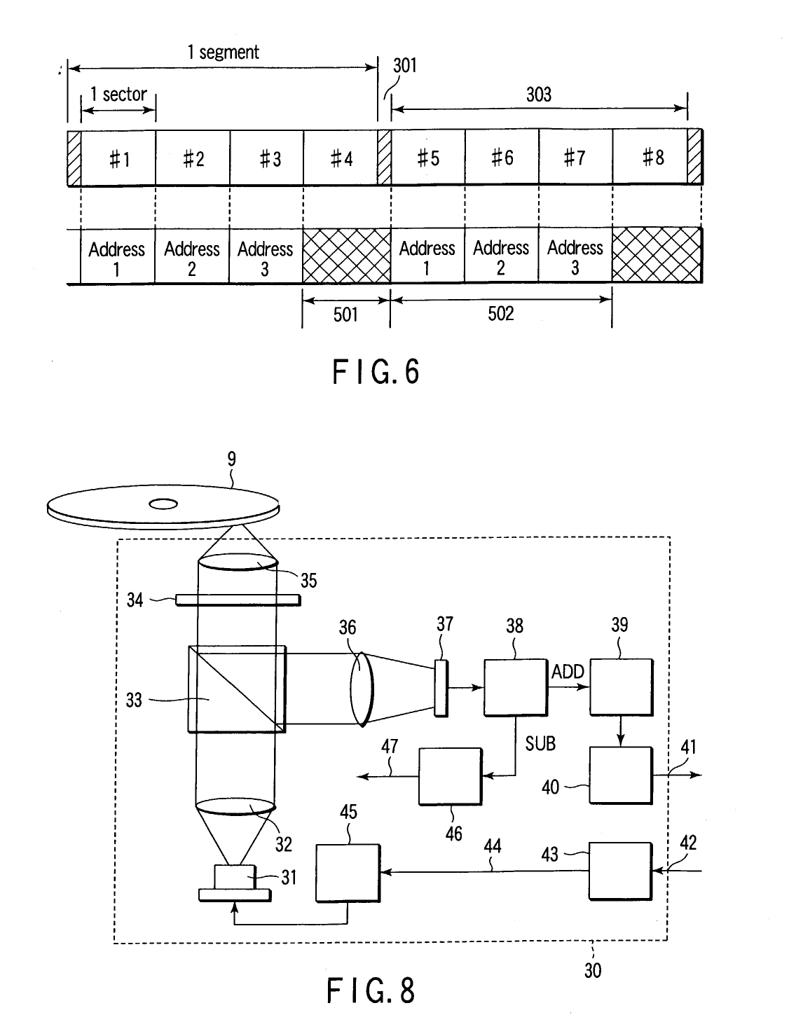

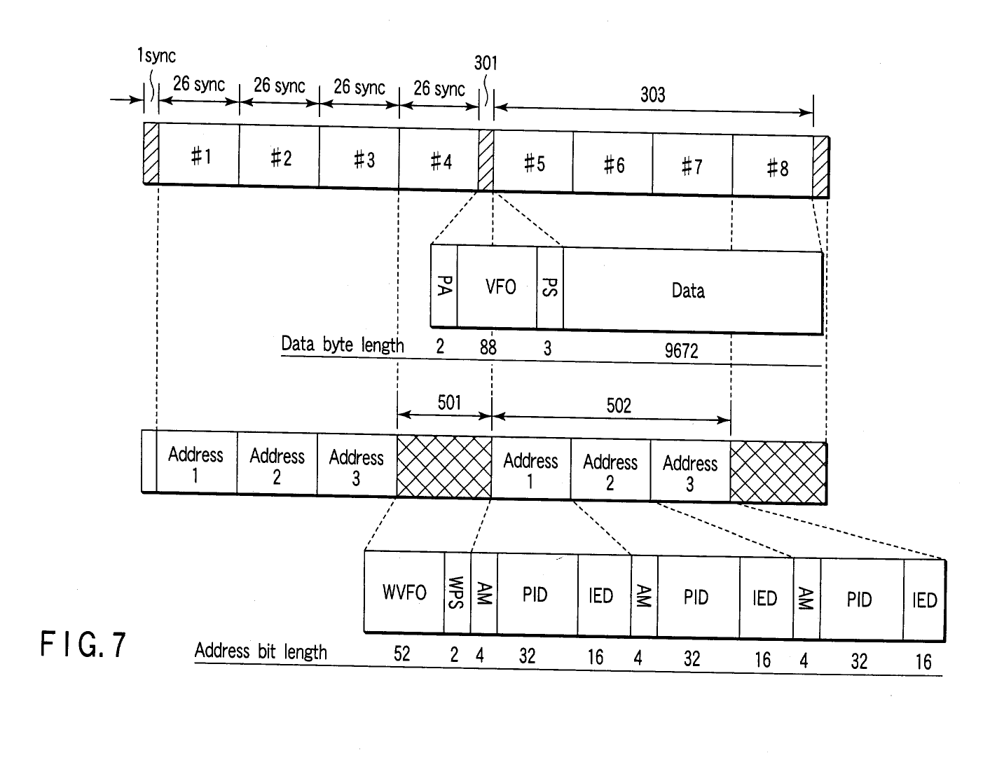

The second embodiment of the present invention will be described below with reference to FIGS. 6 and 7. FIG. 6 is a view showing the layout when one segment has four sectors.

An intermediate area 301 is inserted for every four sectors of user data. A user data recording area 303 can record user data corresponding to four sectors.

On the other hand, for address data, one address is given to one segment, as in the first embodiment. Three addresses (address 1, address 2, and address 3) with identical contents are written in an address data area 502 to ensure a higher reliability for playback than in the first embodiment. One of the three addresses has the same length as that of one sector of user data. A wobble header area 501 has the same length as the total length of one sector of user data and the intermediate area 301.

FIG. 7 shows the internal layouts of user data and address data.

The internal arrangement of user data is the same as in the first embodiment, though the lengths of portions are different. The intermediate area 301 has a length of one sync frame. When one sync frame has a length of 93 bytes, the PA field, VFO field, and PS field have lengths of two bytes, 88 bytes, and three bytes, respectively. The user data of one sector has a length of 26 sync frames. The total length of the VFO field and the PS and PA fields before and after the VFO field is, e.g., one sync frame. The user data recording area 303 has a length of 104 sync frames corresponding to user data of four sectors. This equals 9,672 bytes.

On the other hand, the address data and user data have a spatial positional relationship shown in FIG. 7. Almost in parallel to three-sector data from the start in one segment of user data, three address data item (address 1, address 2, and address 3) are recorded. Hence, each of the three address data item has a length of one sector, i.e., 26 sync frames. The internal arrangement of each address data is the same as in the first embodiment. The wobble header area 501 is recorded almost in parallel to the intermediate area 301 at the start of user data of one segment and the last user data of one sector in the segment immediately before the intermediate area 301. Hence, the wobble header area 501 has a length of 27 sync frames. When the 4-frequency modulation scheme for recording 2-bit data in one sync frame is employed, as in the first embodiment, 54 address bits can be recorded in the wobble header area 501. More specifically, the WVFO field has a length of 52 address bits, and the WPS field has a length of 2 address bits.

The effect of the second embodiment is the same as in the first embodiment except that since the length one segment increases to four sectors, the allowable value of the error length correctable by ECC becomes large.

FIG. 8 is a block diagram showing the schematic arrangement of an information recording/playback apparatus which records information on the information storage medium 9 or plays back information from the information storage medium 9.

A light beam emitted from a laser source 31 is converted into a parallel beam by a collimator lens 32, enters a polarizing beam splitter (to be referred to as a PBS hereinafter) 33, and passes through it. The beam that has passed through the PBS 33 passes through a λ/4 plate 34 and is focused on the information recording surface of the information storage medium 9 through an objective lens 35.

The focused beam is controlled by a focus servo/tracking servo system (not shown) such that an optimum small spot can be obtained on the recording surface.

The beam with which the information storage medium 9 is irradiated is reflected by a reflecting film or reflective recording film in the information recording surface. The reflected light passes through the objective lens 35 in a reverse direction and becomes parallel light again.

The reflected light passes through the λ/4 plate 34 to be vertically polarized with respect to incident light. The light is reflected by the PBS 33. The beam reflected by the PBS 33 converges through a condenser lens 36 and becomes incident on a photodetector 37. The photodetector 37 is divided into two parts by a dividing line parallel to the track tangential direction of the information storage medium 9. The light beam incident on the photodetector 37 is photoelectrically converted into an electrical signal and sent to a preamplifier 38. The preamplifier 38 I/V-converts the two divided element signals from the photodetector 37 and amplifies them. The sum signal from the 2-divided detector, which is amplified by the preamplifier 38, is equalized and binarized by a signal processing circuit 39 and sent to a modulation circuit 40. The modulation circuit 40 executes demodulation corresponding to a predetermined modulation scheme to obtain playback data 41 of recording information.

On the other hand, in recording data, recording data 42 is input to a modulation circuit 43 of an information recording/playback apparatus 30. The modulation circuit 43 executes modulation corresponding to a predetermined modulation scheme for the recording data 42 to generate a channel bit data sequence 44 to be recorded on the disk. The channel bit data sequence 44 is sent to a recording circuit 45 and converted into recording pulses to drive the laser. The recording circuit 45 drives the laser by the recording pulses and records a recording mark sequence corresponding to the data on tracks on the information storage medium 9.

On the other hand, when information is played back from wobbled tracks (grooves 9a) on the information storage medium 9 with the focused beam, the difference signal from the 2-divided photodetector 37, which is amplified by the preamplifier 38, is used to read address data recorded by the wobbles. The difference signal from the 2-divided photodetector, which is output from the preamplifier 38, is sent to an address signal detection circuit 46. The address data recorded in advance is read, and address data 47 is output.

Data is recorded at a target position or read from a target position on the basis of the address data 47. The data here means data with an error correction code.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information storage medium which stores data with an error correction code, comprising:
wobble grooves whose wobble period is modulated in correspondence with address information, wherein a length smaller than a maximum error-correctable data length of the data with the error correction code, which is stored along the wobble grooves, is defined as a basic unit, and the address information in the basic unit is reflected in modulation of the wobble period of the wobble grooves.

2. A medium according to claim 1, wherein the wobble period of the wobble grooves is modulated by multi-frequency shift keying corresponding to the address information.

3. A medium according to claim 1, wherein
the data with the error correction code is data-divisionally stored as n-sector data, and
the address information is reflected in modulation of the wobble period of the wobble grooves corresponding to a data length of one-sector data.

4. A medium according to claim 3, wherein two pieces of address information representing the same position are reflected in modulation of the wobble period of the wobble grooves corresponding to a data length of two-consecutive-sector data.

5. An information recording apparatus for recording information on an information storage medium having wobble grooves whose wobble period is modulated in correspondence with address information, in which a length smaller than a maximum error-correctable data length of the data with the error correction code, which is stored along the wobble grooves, is defined as a basic unit, and the address information in the basic unit is reflected in modulation of the wobble period of the wobble grooves, comprising:
a read section configured to read the address information from modulation of the wobble period of the wobble groove; and
a recording section configured to record target data with an error correction code at a target position on the basis of the address information read by the reading section.

6. An apparatus according to claim 5, wherein the wobble period of the wobble grooves of the information storage medium is modulated by multi-frequency shift keying corresponding to the address information.

7. An apparatus according to claim 5, wherein
the data with the error correction code is data-divisionally stored as n-sector data, and
the address information is reflected in modulation of the wobble period of the wobble grooves corresponding to a data length of one-sector data.

8. An apparatus according to claim 7, wherein two pieces of address information representing the same position are reflected in modulation of the wobble period of the wobble grooves corresponding to a data length of two-consecutive-sector data.

9. An information playback apparatus for playing back information from an information storage medium having wobble grooves whose wobble period is modulated in correspondence with address information, in which a length smaller than a maximum error-correctable data length of the data with the error correction code, which is stored along the wobble grooves, is defined as a basic unit, and the address information in the basic unit is reflected in modulation of the wobble period of the wobble grooves, comprising:
a read section configured to read the address information from modulation of the wobble period of the wobble groove; and
a playback section configured to play back target data with an error correction code from a target position on the basis of the address information read by the reading section.

10. An apparatus according to claim 9, wherein the wobble period of the wobble grooves of the information storage medium is modulated by multi-frequency shift keying corresponding to the address information.

11. An apparatus according to claim 9, wherein
the data with the error correction code is data-divisionally stored as n-sector data, and
the address information is reflected in modulation of the wobble period of the wobble grooves corresponding to a data length of one-sector data.

12. An apparatus according to claim 11, wherein two pieces of address information representing the same position are reflected in modulation of the wobble period of the wobble grooves corresponding to a data length of two-consecutive-sector data.
